(19) United States
(12) Patent Application Publication
(10) Pub. No.: US 2026/0273566 A1
(43) Pub. Date: Sep. 17, 2026

(54) COATING EQUIPMENT

(71) Applicant: TRINITY INDUSTRIAL CORPORATION, Aichi (JP)

(72) Inventors: Masahiro HARADA, Aichi (JP); Ryota SAITO, Aichi (JP)

(73) Assignee: TRINITY INDUSTRIAL CORPORATION, Aichi (JP)

(21) Appl. No.: 19/472,325

(22) PCT Filed: Feb. 23, 2024
(86) PCT No.: PCT/JP2024/006676

§ 371 Date: Dec. 8, 2025

(30) Foreign Application Priority Data
Apr. 6, 2023 (JP) 2023-061878

(51) Int. Cl. B05B 14/43; B05B 13/04; B05B 16/40; B05B 16/60

(52) U.S. Cl. CPC B05B 14/43; B05B 13/0452; B05B 16/40; B05B 16/60

(57) ABSTRACT

The invention provides coating equipment capable of reducing the overall height of a coating booth and facilitating filter replacement. The coating equipment (10) includes a coating booth (11) and a paint mist removal device (30). The coating booth (11) performs coating while conveying an object to be coated (W1) along a longitudinal direction of a coating line (14). The paint mist removal device (30) has a filter housing (31) accommodating a primary filter (40) and a secondary filter (60). Paint mist contained in booth air (A2) discharged from a booth space (S1) is removed by allowing the booth air (A2) to flow through the primary and secondary filters (40, 60) in the filter housing (31). The paint mist removal device (30) is installed at a position offset in a width direction of the coating line (14) while avoiding a booth underfloor space (S2).

### TECHNICAL FIELD

The present invention relates to coating equipment including a coating booth for applying paint to a workpiece and a paint mist removal device for removing paint mist from the air in the booth.

### BACKGROUND ART

Conventionally, coating equipment for coating workpieces such as vehicle bodies has been known. For example, as shown in FIG. 15, in coating equipment 101, it has been proposed to install a paint mist removal device 104 in a space 103 beneath the floor of a coating booth 102 (see, for example, Patent Document 1). The paint mist removal device 104 includes a filter housing 107 accommodating a primary filter 105 and a secondary filter 106, and removes paint mist from booth air A1 discharged from a booth space 108 of the coating booth 102. The primary filter 105 takes in booth air A1 from above (from the booth space 108 side) and discharges it laterally (to the right side in FIG. 15). A secondary filter 106 is arranged adjacent to the side of the primary filter 105.

### PRIOR ART DOCUMENT

### Patent Documents

Patent Document 1: Japanese Patent Application Publication No. 2021-133269

### DISCLOSURE OF THE INVENTION

### Problems to Be Solved by the Invention

However, when the paint mist removal device 104 is installed in the space 103 beneath the floor of the coating booth, a worker must enter the space 103 beneath the booth floor to perform maintenance of the paint mist removal device 104, such as replacing filters. In this case, to facilitate the worker's entry, the space 103 beneath the booth floor must be made higher, which results in an increase in the overall height of the coating booth 102 and causes restrictions on the installation location.

In addition, as shown in FIG. 15, an exhaust duct 109 for discharging booth air A1 outside the coating equipment 101 is provided on the side (the right side in FIG. 15) of the secondary filter 106. In this case, the worker can access the paint mist removal device 104 only from the opposite side where the exhaust duct 109 is not provided (the left side in FIG. 15). Therefore, when replacing the secondary filter 106, the primary filter 105 must first be removed from the paint mist removal device 104 before taking out the secondary filter 106. This complicates the replacement operation.

The present invention has been made in view of the above problems, and an object thereof is to provide coating equipment that can reduce the overall height of a coating booth and allows filters to be replaced easily.

### Means for Solving the Problems

To achieve the above object, the first aspect of the present invention is directed to a coating equipment comprising: a coating booth having a pair of side walls and a floor portion, wherein a booth space accommodating a coating line is defined above the floor portion, and a booth underfloor space is defined below the floor portion, the coating booth being configured to coat a workpiece while conveying the workpiece along a longitudinal direction of the coating line; and a paint mist removal device having a filter housing capable of accommodating a primary filter and a secondary filter, the paint mist removal device being configured to remove paint mist contained in booth air discharged from the booth space by causing the booth air to flow through the primary and secondary filters accommodated in the filter housing; wherein the paint mist removal device is installed at a position offset in a width direction of the coating line, so as to avoid the booth underfloor space.

According to the first aspect of the present invention, the paint mist removal device is installed at a position offset in the width direction of the coating line so as to avoid the booth underfloor space of the coating booth. As a result, the height of the booth underfloor space can be reduced by an amount corresponding to the height of the paint mist removal device, thereby reducing the overall height of the coating booth. This increases the freedom of installation of the coating booth. Furthermore, when a worker replaces the primary and secondary filters housed in the filter housing of the paint mist removal device, it is not necessary for the worker to enter the booth underfloor space. Therefore, replacement of the primary and secondary filters can be performed easily.

The second aspect of the present invention is directed to the coating equipment, characterized in that, in the coating equipment according to claim 1, the paint mist removal device is installed at a position spaced apart from the side wall.

The third aspect of the present invention is directed to the coating equipment according to the second aspect, wherein an exhaust duct is connected to an outlet of the filter housing, and the exhaust duct is installed at a position offset in the width direction of the coating line so as to avoid the booth underfloor space.

According to the third aspect of the present invention, the exhaust duct is installed at a position offset in the width direction of the coating line so as to avoid the booth underfloor space of the coating booth. As a result, the height of the booth underfloor space can be reduced by an amount corresponding to the height of the exhaust duct, thereby reducing the overall height of the coating booth. This increases the freedom of installation of the coating booth.

The fourth aspect of the present invention is directed to the coating equipment according to the first aspect of the present invention, wherein the primary filter and the secondary filter are arranged vertically adjacent to each other within the filter housing.

According to the fourth aspect of the present invention, even when another structure is disposed adjacent to a side of the filter housing, one of the primary and secondary filters can be replaced without being obstructed by the other filter or by another structure. Furthermore, since the primary and secondary filters are arranged vertically adjacent to each other, the installation area of the filter housing (i.e., the paint mist removal device) can be reduced, thereby increasing the degree of freedom in installing the paint mist removal device.

The fifth aspect of the present invention refers to the coating equipment according to the fourth aspect, wherein the filter housing includes a lower housing portion and an upper housing portion. The primary filter is removably accommodated in the lower housing portion, and the secondary filter is removably accommodated in the upper housing portion.

According to the fifth aspect of the present invention, since the primary and secondary filters can be removed, a worker can clean the inside of the filter housing with the filters removed. Therefore, the workability of cleaning the filter housing can be improved.

The sixth aspect of the present invention refers to the coating equipment according to the fifth aspect, wherein the filter housing has an inlet for introducing booth air into the primary filter in the lower housing portion, and an outlet for discharging the booth air from the secondary filter in the upper housing portion.

According to the sixth aspect of the present invention, since the filter housing has an inlet and an outlet, booth air is guided in the order of the inlet, the primary filter, the secondary filter, and the outlet. Therefore, when an exhaust duct is connected to the outlet of the filter housing, the exhaust duct is located above the filter housing, and the exhaust duct does not interfere with the worker.

The seventh aspect of the present invention refers to the coating equipment according to any one of the first to sixth aspects, wherein an air transfer passage connecting the booth space and the paint mist removal device is formed in the booth underfloor space, and a dust collection section for removing paint mist contained in the booth air is provided at a position on the air transfer passage.

According to the seventh aspect of the present invention, booth air collides with the inner surface of the dust collection section, and the paint mist contained in the booth air adheres to the inner surface of the dust collection section, thereby allowing the paint mist to be collected.

The eighth aspect of the present invention refers to the coating equipment according to the seventh aspect, wherein the air transfer passage includes a descending duct extending downward from the center of the floor portion, a direction-changing section connected to the end of the descending duct for changing the traveling direction of the booth air, and a transverse duct connected to the direction-changing section and extending laterally toward the paint mist removal device. The direction-changing section is provided with the dust collection section, and the transverse duct is formed with a rectifying section having a bottom surface sloping downward toward the direction-changing section.

According to the eighth aspect of the present invention, booth air collides with the inner surface of the direction-changing section, and paint mist contained in the booth air adheres to the inner surface of the direction-changing section, thereby allowing the paint mist to be collected. Furthermore, the bottom surface of the transverse duct constituting the air transfer passage slopes downward toward the direction-changing section. Therefore, when a cleaning liquid is poured into the transverse duct, paint mist adhering to the inner surface of the transverse duct flows into the direction-changing section together with the cleaning liquid, whereby the air transfer passage can be easily cleaned.

The ninth aspect of the present invention refers to the coating equipment according to the eighth aspect, wherein a sump is provided at a lower part of the dust collection section.

According to the ninth aspect of the present invention, paint mist deposited in the direction-changing section (dust collection section) can be concentrated in the sump.

### Effect of the Invention

As described in detail above, according to the first to ninth aspects of the present invention, it is possible to provide coating equipment capable of reducing the overall height of the coating booth and facilitating replacement of filters.

### BRIEF DESCRIPTION OF THE DRAWINGS

FIG. 1 is a schematic sectional view showing coating equipment according to an embodiment of the present invention.

FIG. 2 is a front view showing a paint mist removal device.

FIG. 3 is a sectional view showing a paint mist removal device.

FIG. 4 is a sectional view showing a lower housing portion and a corrugated cardboard filter.

FIG. 5 is a sectional view showing an upper housing portion and a secondary filter.

FIG. 6 is a schematic sectional view showing a state in which the corrugated cardboard filter and the secondary filter are inserted into or removed from the filter housing.

FIG. 7 is a perspective view showing the paint mist removal device when an open/close door is opened.

FIG. 8 is a sectional view showing a paint mist removal device according to another embodiment.

FIG. 9 is a schematic sectional view showing an air transfer passage according to another embodiment.

FIG. 10 is a schematic sectional view showing an air transfer passage according to another embodiment.

FIG. 11 is a schematic sectional view showing an air transfer passage according to another embodiment.

FIG. 12 is a schematic sectional view showing coating equipment according to another embodiment.

FIG. 13(a) is a schematic sectional view showing coating equipment according to another embodiment, and FIG. 13(b) is a sectional view taken along line A-A of FIG. 13(a).

FIG. 14 is a schematic sectional view showing coating equipment according to another embodiment.

FIG. 15 is a schematic sectional view showing coating equipment according to prior art.

### BEST MODE FOR CARRYING OUT THE INVENTION

Hereinafter, embodiments of the coating equipment according to the present invention will be described with reference to the drawings.

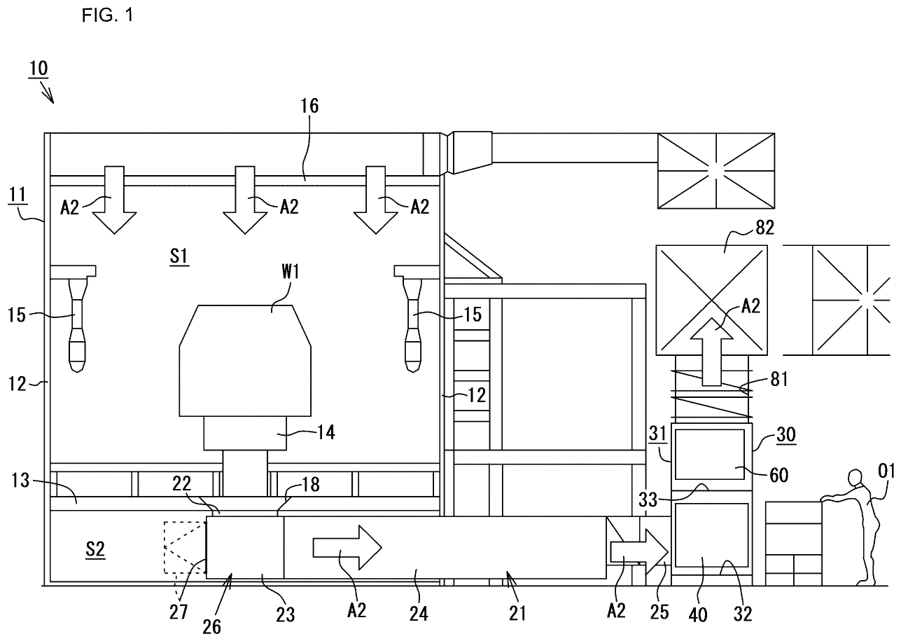

As shown in FIG. 1, the coating equipment 10 of this embodiment includes a coating booth 11 and a paint mist removal device 30. The coating booth 11 has a pair of side walls 12 and a floor portion 13. A booth space S1 is defined above the floor portion 13 of the coating booth 11, and a booth underfloor space S2 is defined below the floor portion 13. In the booth space S1, a coating line 14 extending in the longitudinal direction (a direction perpendicular to the plane of FIG. 1) and a plurality of coating robots 15 disposed on both sides of the coating line 14 are accommodated. In the coating booth 11, a workpiece W1 (a vehicle body in this embodiment) is coated by spraying atomized paint (paint mist) from coating guns of the coating robots 15 onto the workpiece W1, while the workpiece W1 is conveyed along the longitudinal direction of the coating line 14.

A ceiling wall 16 is provided in an upper part of the booth space S1. The ceiling wall 16 has a mesh structure, and booth air A2 is supplied to its upper side. As a result, the booth air A2 passes through the ceiling wall 16 and flows downward inside the coating booth 11, whereby paint mist that has not adhered to the workpiece W1 is guided downward. Meanwhile, an exhaust port 18 is provided at the center of the floor portion 13.

As shown in FIG. 1, an air transfer passage 21 connecting the booth space S1 and the paint mist removal device 30 is formed in the booth underfloor space S2. The air transfer passage 21 includes a descending duct 22, a direction-changing section 23, and a transverse duct 24. The descending duct 22 has a rectangular cross-section and extends downward from an exhaust port 18 provided at the center of the floor portion 13. The direction-changing section 23 has a box-shaped structure and is connected to the lower end of the descending duct 22. The direction-changing section 23 changes the traveling direction of the booth air A2 passing through the descending duct 22 from a downward direction to a lateral direction (rightward in FIG. 1). The transverse duct 24 also has a rectangular cross-section. Its proximal end is connected to the direction-changing section 23, and its distal end is connected to the paint mist removal device 30 via a connection duct 25. The transverse duct 24 penetrates the side wall 12 and projects outward from the coating booth 11 (i.e., outside the booth underfloor space S2), extending laterally (rightward in FIG. 1) toward the paint mist removal device 30. The connection duct 25 also has a rectangular cross-section and extends laterally (rightward in FIG. 1) toward the paint mist removal device 30. The flow-path cross-sectional area of the connection duct 25 is smaller than that of the transverse duct 24.

As shown in FIG. 1, the direction-changing section 23, which is located on the way along the air transfer passage 21, serves as a dust collection section 26.

The dust collection section 26 is configured to cause the booth air A2 that has passed through the descending duct 22 to collide with an inner surface (particularly a bottom surface) of the dust collection section 26, thereby allowing a portion of the paint mist contained in the booth air A2 to adhere to the bottom surface and be removed (collected). A door 27 is provided on a side portion of the dust collection section 26, specifically on the side opposite to the portion where the dust collection section 26 is connected to the transverse duct 24 (i.e., the left side in FIG. 1), so as to isolate the inside of the dust collection section 26 from the outside.

The paint mist removal device 30 is a device that removes paint mist contained in the booth air A2 discharged from the coating booth 11. The paint mist removal device 30 is installed at a position offset in the width direction of the coating line 14 (rightward in FIG. 1) so as to avoid the booth underfloor space S2. The paint mist removal device 30 is located at a distance from the side wall 12 of the coating booth 11 that is greater than the length of at least the connection duct 25.

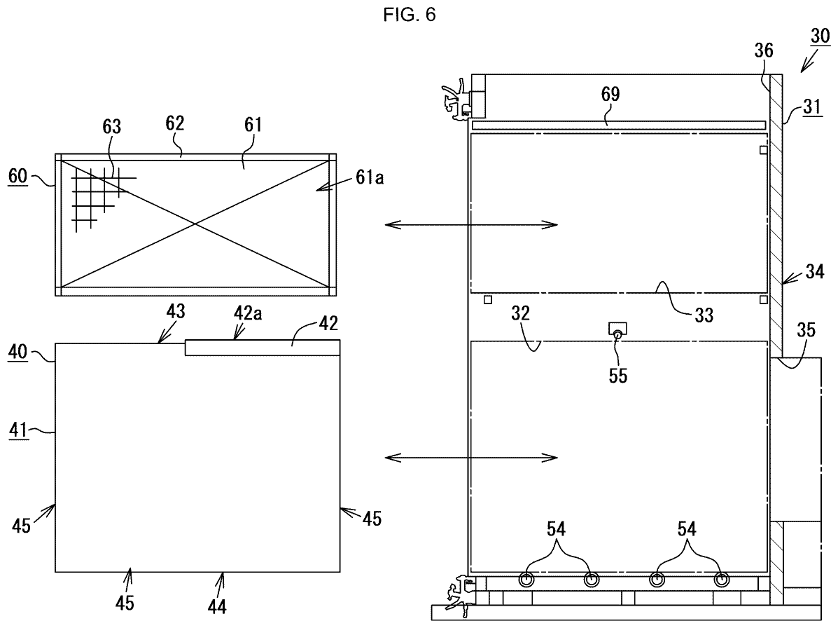

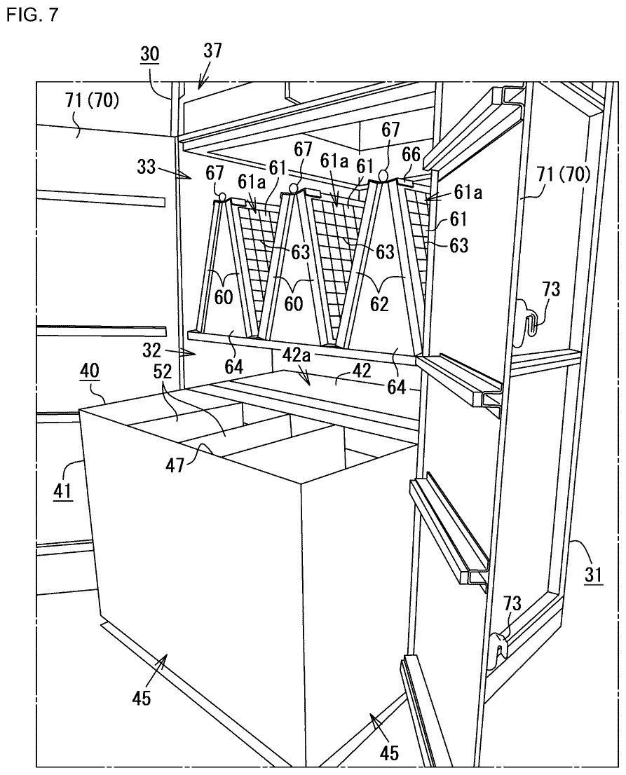

As shown in FIGS. 1 and 3 to 7, the paint mist removal device 30 includes a filter housing 31 capable of accommodating one corrugated cardboard filter 40 (primary filter) and six secondary filters 60. The paint mist removal device 30 is a device that removes paint mist contained in the booth air A2 discharged from the booth space S1 by allowing the booth air A2 to flow through the corrugated cardboard filter 40 and the secondary filters 60 accommodated in the filter housing 31. Specifically, the filter housing 31 includes a lower housing portion 32 and an upper housing portion 33 disposed adjacent to each other, the upper housing portion 33 being located above the lower housing portion 32. The lower housing portion 32 is configured such that the corrugated cardboard filter 40 can be inserted into and removed from it (see FIGS. 6 and 7), and the upper housing portion 33 is configured such that each of the secondary filters 60 can be inserted into and removed from it (see FIG. 6). Accordingly, the corrugated cardboard filter 40 and the secondary filters 60 are arranged vertically adjacent to each other within the filter housing 31. The height of the filter housing 31 is greater than the height of the booth underfloor space S2 of the coating booth 11. Furthermore, the height of the lower housing portion 32 is also greater than the height of the booth underfloor space S2. Therefore, the upper housing portion 33 is positioned above the floor portion 13 of the coating booth 11.

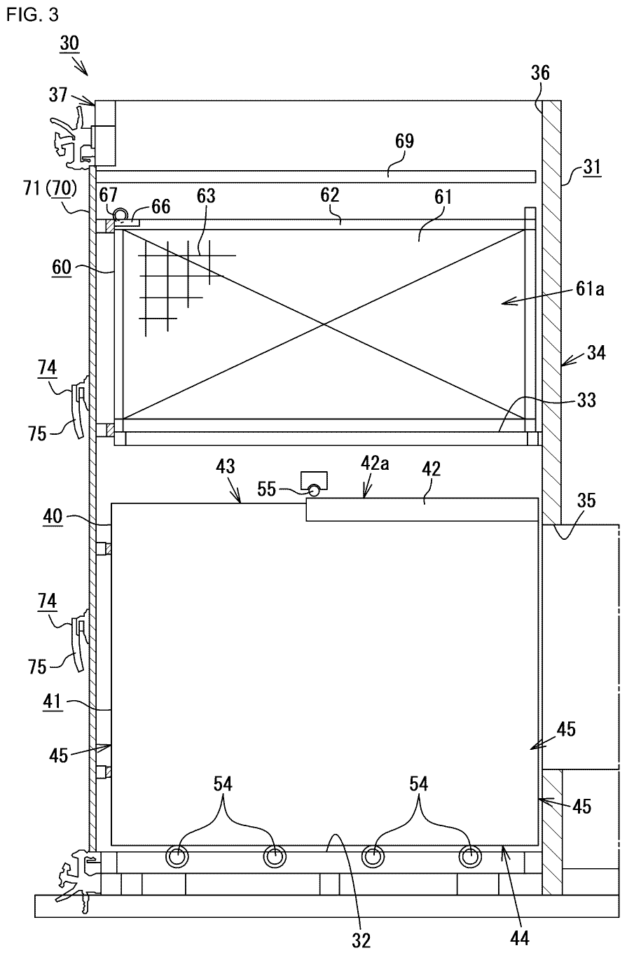

As shown in FIGS. 3 to 6, an inlet port 35 is provided in a side surface 34 of the filter housing 31 (specifically, in a portion of the side surface 34 located opposite to the opening of the lower housing portion 32). The inlet port 35 is connected to the terminal end of the connection duct 25. The inlet port 35 serves to introduce booth air A2 into the corrugated cardboard filter 40 within the lower housing portion 32. Furthermore, an outlet port 36 is provided at a position higher than the inlet port 35 in the filter housing 31 (specifically, at an upper end portion of the filter housing 31). The outlet port 36 serves to discharge the booth air A2 that has passed through the secondary filters 60 within the upper housing portion 33.

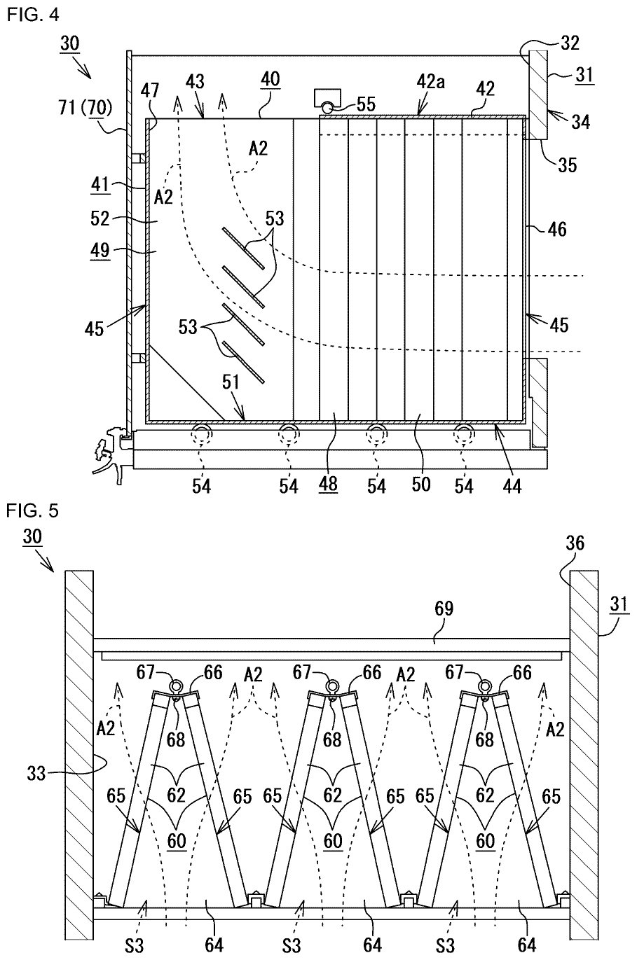

The corrugated cardboard filter 40 is mainly made of a combustible material (specifically, corrugated cardboard). As shown in FIGS. 3, 4, 6, and 7, the corrugated cardboard filter 40 includes a filter body 41 and an upper lid portion 42. The filter body 41 has a rectangular parallelepiped (box-shaped) configuration including an upper surface 43, a lower surface 44, and four side surfaces 45. The filter body 41 further has a rectangular inlet 46 opened in a side surface 45 on the upstream side (the right side in FIG. 4) and a rectangular outlet 47 opened in the upper surface 43. The upper lid portion 42 covers the upper surface 43 of the filter body 41 except for the outlet 47. In the filter body 41 of the present embodiment, booth air A2 containing paint mist flows into the interior from the inlet 46 and is discharged from the outlet 47. The booth air A2 discharged from the outlet 47 is guided into the upper housing portion 33.

As shown in FIG. 4, the filter body 41 is provided with an eliminator 48 and a rectifying plate 49. The eliminator 48 is housed near the inlet 46 inside the filter body 41. The eliminator 48 is composed of a plurality of plate-shaped eliminator elements 50 arranged in parallel and has a function of separating paint mist from the booth air A2. Each eliminator element 50 extends in the vertical direction, and its lower end is in contact with a bottom surface 51 of the filter body 41. The bottom surface 51 is parallel to the upper surface 43 and the lower surface 44 of the filter body 41. Each eliminator element 50 has a zigzag shape when viewed in plan view. Accordingly, meandering passages are formed between adjacent eliminator elements 50.

The rectifying plate 49 is housed near the outlet 47 inside the filter body 41. The rectifying plate 49 is composed of a plurality of rectifying plate elements 52 arranged in parallel. Each rectifying plate element 52 extends in the vertical direction, and its lower end is in contact with the bottom surface 51 of the filter body 41. Each rectifying plate element 52 also extends in the horizontal direction (left-right direction in FIG. 4), and its upstream end is connected to the downstream end of the eliminator element 50.

As shown in FIG. 4, the rectifying plate 49 includes four guide plates 53 that connect the rectifying plate elements 52 to one another. Each guide plate 53 is orthogonal to the rectifying plate elements 52 and extends in the horizontal direction (depth direction in FIG. 4). Each guide plate 53 is inclined with respect to the upper surface 43, the lower surface 44, and the bottom surface 51 of the filter body 41, and functions to guide the booth air A2, which has been introduced from the inlet 46 and has passed through the eliminator 48, toward the outlet 47.

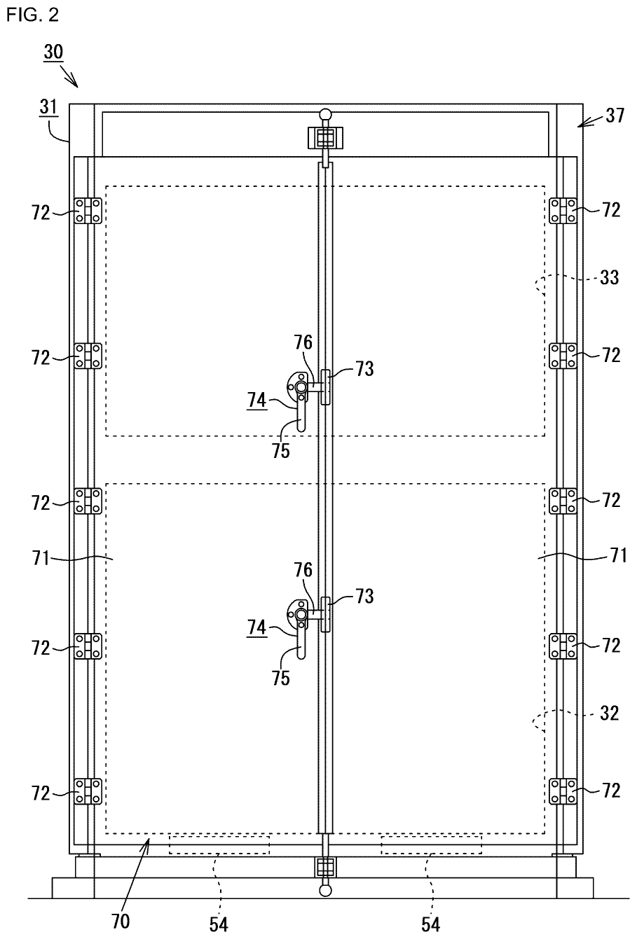

As shown in FIGS. 2 to 4 and 6, a plurality of rollers 54 are rotatably arranged at predetermined intervals at the bottom of the lower housing portion 32. The rotation axis of each roller 54 is orthogonal to the direction in which the corrugated cardboard filter 40 is inserted and removed (left-right direction in FIG. 6). The dimension of each roller 54 in the direction of its rotation axis is set to be smaller than the depth dimension of the corrugated cardboard filter 40. All the rollers 54 are positioned at the same height and are arranged in a straight line along the direction in which the corrugated cardboard filter 40 is inserted and removed. Accordingly, the outer peripheral surfaces of the rollers 54 are in contact with the lower surface 44 side of the corrugated cardboard filter 40, thereby supporting the corrugated cardboard filter 40 from below. When the corrugated cardboard filter 40 is conveyed, the rollers 54 rotate, thereby promoting smooth movement of the corrugated cardboard filter 40.

As shown in FIGS. 3, 4, and 6, a pressing member 55 that can come into contact with the upper surface 43 of the filter body 41 is provided on an upper portion of an inner surface of the lower housing portion 32. Specifically, the pressing member 55 is a rod-shaped member having a circular cross section and is provided at a position where it can come into contact with an upper surface 42a of the upper lid portion 42. The pressing member 55 is detachably provided with respect to the lower housing portion 32.

As shown in FIGS. 3 and 5 to 7, the secondary filter 60 includes two sheet-like filter elements 61, a filter frame 62, and a pair of mesh members 63. Each sheet-like filter element 61 is mainly made of a combustible material (specifically, fire-retardant treated paper) and is formed in a rectangular plate shape. The sheet-like filter elements 61 serve to remove paint mist contained in the booth air A2 by allowing the booth air A2 discharged from the corrugated cardboard filter 40 to pass therethrough. The filter frame 62 has a rectangular frame shape and holds outer peripheral portions of the two sheet-like filter elements 61. Each mesh member 63 has its outer peripheral portion held by the filter frame 62 and supports the air inflow surface (not shown) and the air outflow surface 61a of the sheet-like filter element 61, respectively. This prevents the sheet-like filter elements 61 from falling off the filter frame 62.

As shown in FIGS. 5 and 7, three secondary filter mounting portions 64 are accommodated in the upper housing portion 33. The secondary filter mounting portions 64 are arranged side by side along the lateral direction (left-right direction in FIG. 5). Each secondary filter mounting portion 64 has a trapezoidal shape having sloped surfaces 65 on both sides (the left and right sides in FIG. 5). By bringing the secondary filters 60 into close contact with the respective sloped surfaces 65, a pair of secondary filters 60 are mounted on each secondary filter mounting portion 64 in such a manner that the pair of secondary filters 60 approach each other toward the upper side. In this state, the air inflow surfaces of the sheet-like filter elements 61 face the sloped surfaces 65.

Furthermore, a holding member 66 is provided at an upper end portion of each secondary filter mounting portion 64. The holding member 66 is formed into a substantially U-shaped cross section by bending a rectangular metal plate. The holding member 66 is configured to hold upper portions of the filter frames 62 of the pair of secondary filters 60 mounted on the secondary filter mounting portion 64. As a result, each secondary filter 60 closely contacts the corresponding secondary filter mounting portion 64. An eye bolt 67 is inserted through a central portion of the holding member 66 and an upper end portion of the secondary filter mounting portion 64, and a nut 68 is threaded onto a distal end portion of the inserted eye bolt 67, thereby fastening the holding member 66 and the secondary filter mounting portion 64 together. Thus, each secondary filter 60 mounted on the secondary filter mounting portion 64 is fixed in place.

As shown in FIGS. 3, 5, and 6, an air volume adjusting plate 69 is provided at an upper portion of the upper housing portion 33 to adjust the air volume of the booth air A2 that has passed through the respective secondary filters 60. The air volume adjusting plate 69 may adjust the air volume of the booth air A2 by sliding a panel that constitutes a part of the air volume adjusting plate 69 (i.e., moving the panel in the plane direction of the air volume adjusting plate 69), or alternatively, by removing the panel.

As shown in FIGS. 2, 3, and 7, on a side surface 37 of the filter housing 31, which is located opposite to the side surface 34 where the inlet port 35 is provided (that is, the side surface 37 on which the openings of the lower housing portion 32 and the upper housing portion 33 are located), an open/close door 70 composed of a pair of swing doors 71 is provided. The two swing doors 71 are rotatably connected to both side edges of the side surface 37 via a plurality of hinges 72 and are configured to respectively close half of the opening of the lower housing portion 32 and half of the opening of the upper housing portion 33. In other words, the open/close door 70 of the present embodiment serves as a common door for inserting and removing the corrugated cardboard filter 40 with respect to the lower housing portion 32 and for inserting and removing the secondary filters 60 with respect to the upper housing portion 33. Accordingly, when the open/close door 70 is opened, both replacement of the corrugated cardboard filter 40 and replacement of the secondary filter 60 can be performed.

As shown in FIG. 2, among the pair of swing doors 71 constituting the open/close door 70, a pair of locking portions 73 are provided on the front surface of one swing door 71 (the right-side swing door 71 in FIG. 2). On the front surface of the other swing door 71 (the left-side swing door 71 in FIG. 2), which does not have the locking portions 73, a pair of lock levers 74 are provided. Each lock lever 74 is rotatably supported on the corresponding swing door 71 and includes an operation bar 75 and an action bar 76. When the operation bar 75 is rotated, the action bar 76 enters the locking portion 73, thereby locking the pair of swing doors 71 in the closed state.

As shown in FIG. 1, a proximal end of an ascending duct 81 is connected to the outlet port 36 of the filter housing 31 (see FIGS. 3, 5, and 6). The ascending duct 81 has a rectangular cross section and extends upward from the outlet port 36. An exhaust duct 82 is connected to a distal end of the ascending duct 81, and discharges the booth air A2 that has been discharged from the outlet port 36 and has passed through the ascending duct 81. The ascending duct 81 and the exhaust duct 82 are installed at positions offset in the width direction of the coating line 14 (rightward in FIG. 1) so as to avoid the booth underfloor space S2 of the coating booth 11. Furthermore, the ascending duct 81 and the exhaust duct 82 are located at a distance from the side wall 12 of the coating booth 11 corresponding to a total length of “half the length of the transverse duct 24 of the air transfer passage 21” and “the length of the connection duct 25.” The ascending duct 81 and the exhaust duct 82 are positioned above the floor portion 13 of the coating booth 11 and are arranged adjacent to the upper side of the paint mist removal device 30 (filter housing 31).

The inside of the air transfer passage 21, the inside of the filter housing 31, the inside of the ascending duct 81, and the inside of the exhaust duct 82 are maintained under negative pressure by a blower (not shown). Accordingly, the booth air A2 in the coating booth 11 flows into the paint mist removal device 30 after passing through the air transfer passage 21. The paint mist contained in the booth air A2 is removed while passing through the dust collection section 26 and the paint mist removal device 30.

Next, a method for removing paint mist contained in the booth air A2 will be described below.

First, when paint is sprayed from the coating gun of the coating robot 15 to coat the workpiece W1, oversprayed paint mist, together with the booth air A2 in the booth space S1, passes through the exhaust port 18 of the floor portion 13 of the coating booth 11 and is guided to the booth underfloor space S2.

Subsequently, the booth air A2 containing paint mist passes through the descending duct 22 of the air transfer passage 21 formed in the booth underfloor space S2 and is guided to the direction-changing section 23 (serving as the dust collection section 26). When the booth air A2 collides with the inner surface (particularly the bottom surface) of the dust collection section 26, part of the paint mist contained in the booth air A2 adheres to the inner surface, thereby allowing the dust collection section 26 to collect the paint mist. As the booth air A2 collides with the inner surface of the dust collection section 26 (the direction-changing section 23), its traveling direction changes from downward to lateral (rightward in FIG. 1). The booth air A2 whose traveling direction has been changed then flows into the transverse duct 24 of the air transfer passage 21. After passing through the transverse duct 24, the booth air A2 flows through the connection duct 25, sequentially passes through the inlet port 35 of the filter housing 31 (paint mist removal device 30) and the inlet 46 of the corrugated cardboard filter 40 (filter body 41) in the lower housing portion 32, and is taken into the interior of the filter body 41 (see FIG. 4).

Then, the booth air A2 is guided to the eliminator 48 and flows between adjacent eliminator elements 50. Since each eliminator element 50 has a zigzag shape in plan view, a meandering passage is formed between the adjacent elements. As a result, the booth air A2 flows through the meandering passage while colliding with the surfaces of the eliminator elements 50, so that most of the paint mist contained in the booth air A2 is removed by adhesion to their surfaces.

Next, the booth air A2 that has passed through the eliminator 48 is guided to the straightening plate 49 located on the downstream side of the eliminator (left side in FIG. 4) and flows between adjacent straightening plate elements 52. Upon contacting the surfaces of the straightening plate elements 52, the booth air A2 is guided along their surfaces, resulting in a uniform flow. Part of the paint mist contained in the booth air A2 is removed by adhesion to the surfaces of the straightening plate elements 52. Furthermore, the booth air A2 contacts the surfaces of the guide plates 53, thereby changing its traveling direction from lateral (leftward in FIG. 4) to upward. At this time, part of the paint mist contained in the booth air A2 is removed by adhesion to the surfaces of the guide plates 53.

Subsequently, the booth air A2 is discharged from the outlet 47 to the outside of the filter body 41 and guided into the upper housing portion 33. Furthermore, the booth air A2 is guided into an internal space S3 (see FIG. 5) of the secondary filter mounting portion 64 installed in the upper housing portion 33, and passes through the sheet-like filter elements 61 of the secondary filters 60 from the air inflow surface side to the air outflow surface 61 a side (see FIG. 3). During this process, the paint mist contained in the booth air A2 is removed by adhesion to the air inflow surfaces and other portions of the sheet-like filter elements 61. At this stage, the paint mist contained in the booth air A2 is almost completely removed.

Then, the booth air A2 from which the paint mist has been removed passes through the airflow adjustment plate 69 in the upper housing portion 33 and is discharged to the outside of the filter housing 31 through the outlet port 36. Thereafter, the booth air A2 passes through the ascending duct 81 and is discharged to the outside of the coating equipment 10 through the exhaust duct 82.

Accordingly, the following advantages can be achieved in the present embodiment.
(1) In the present embodiment, the coating equipment 10 includes a paint mist removal device 30 installed at a position offset in the width direction of the coating line 14, so as to avoid the booth underfloor space S2 of the coating booth 11. As a result, the height of the booth underfloor space S2 can be reduced by an amount corresponding to the height of the paint mist removal device 30 (for example, to 1100 mm, which is lower than the height of a typical worker 01). Consequently, the overall height of the coating booth 11 can be reduced, thereby increasing the degree of freedom in installing the coating booth 11. In addition, when the worker O1 (see FIG. 1) replaces the corrugated cardboard filter 40 and the secondary filter 60 accommodated in the filter housing 31 of the paint mist removal device 30, the worker O1 does not need to enter the booth underfloor space S2. Accordingly, the replacement of the corrugated cardboard filter 40 and the secondary filter 60 can be performed easily.
(2) In the present embodiment, since the paint mist removal device 30 is located at a position spaced apart from the side wall 12 of the coating booth 11, it can be installed without interference from the coating booth 11. In addition, the corrugated cardboard filter 40 and the secondary filter 60 are arranged vertically adjacent to each other within the filter housing 31 of the paint mist removal device 30. Accordingly, when either the corrugated cardboard filter 40 or the secondary filter 60 is replaced, the replacement operation can be performed without being hindered by the other filter or another structure (for example, the coating booth 11).
(3) In the present embodiment, the corrugated cardboard filter 40 and the secondary filter 60 accommodated in the filter housing 31 are arranged vertically adjacent to each other, and the ascending duct 81 and the exhaust duct 82 are disposed adjacent to the upper side of the filter housing 31. As a result, the installation footprint of the filter housing 31 (i.e., the paint mist removal device 30), together with the ascending duct 81 and the exhaust duct 82, can be reduced. Consequently, because the installation footprint is smaller, the degree of freedom in installing the paint mist removal device 30 is increased.
(4) In the present embodiment, the booth air A2 collides with the inner surface of the dust collection section 26, and the paint mist contained in the booth air A2 adheres to the inner surface, thereby enabling collection of the paint mist. As a result, part of the paint mist contained in the booth air A2 is removed before the booth air A2 is introduced into the paint mist removal device 30. Accordingly, by removing the paint mist from the booth air A2 introduced into the paint mist removal device 30, the booth air A2 can be reliably purified. Furthermore, since the paint mist is collected in the dust collection section 26, the load applied to the paint mist removal device 30 is reduced, making it less likely that paint mist accumulates in the corrugated cardboard filter 40 or the secondary filter 60. Therefore, the service life of the corrugated cardboard filter 40 and the secondary filter 60 can be prolonged.
(5) In the present embodiment, a door 27 that closes off the interior of the dust collection section 26 from the exterior is installed in the dust collection section 26. With this configuration, access to areas inside the dust collection section 26 that tend to become dirty is facilitated, allowing the worker O1 to open the door 27 and enter the section for cleaning.

It is to be noted that the above embodiment may be modified as follows.

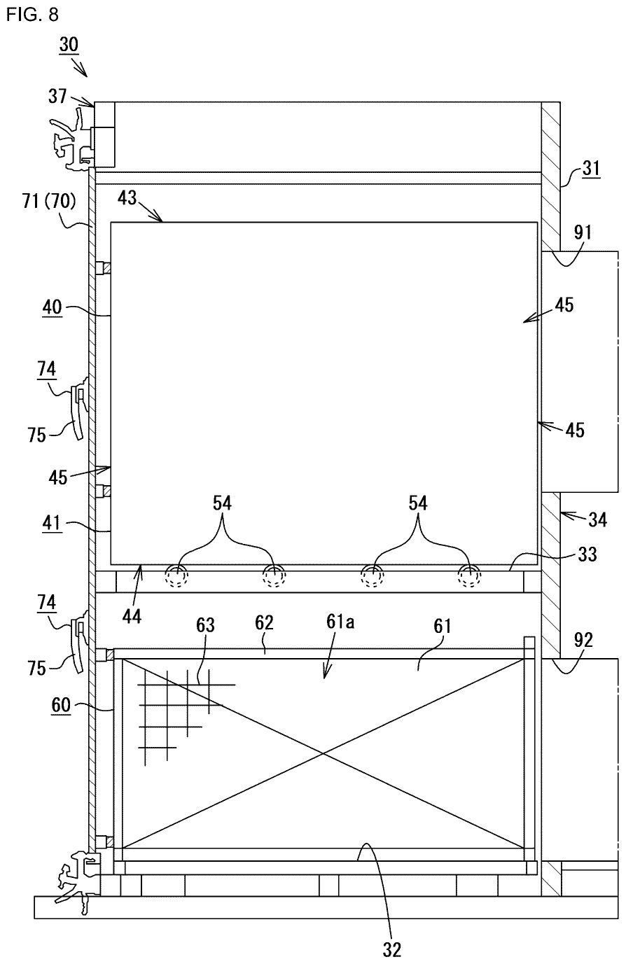

In the filter housing 31 (paint mist removal device 30) of the above-described embodiment, the corrugated cardboard filter 40 is accommodated in the lower housing portion 32, and the secondary filters 60 are accommodated in the upper housing portion 33. However, as shown in FIG. 8, the secondary filters 60 may alternatively be accommodated in the lower housing portion 32, and the corrugated cardboard filter 40 may be accommodated in the upper housing portion 33. In this case, the booth air A2 that has passed through the transverse duct 24 of the air transfer passage 21 passes through the connection duct 25 and then sequentially passes through, for example, the inlet port 91 of the filter housing 31 and the inlet 46 of the corrugated cardboard filter 40 in the upper housing portion 33, and is introduced into the interior of the filter body 41. The booth air A2 is then discharged from an outlet (not shown) provided in the bottom surface 44 of the filter body 41 to the outside of the filter body 41 and guided into the lower housing portion 32. Subsequently, the booth air A2 passes through the sheet-like filter elements 61 of the secondary filters 60 installed in the lower housing portion 32. Thereafter, the booth air A2 is discharged to the outside of the filter housing 31 through an outlet port 92.

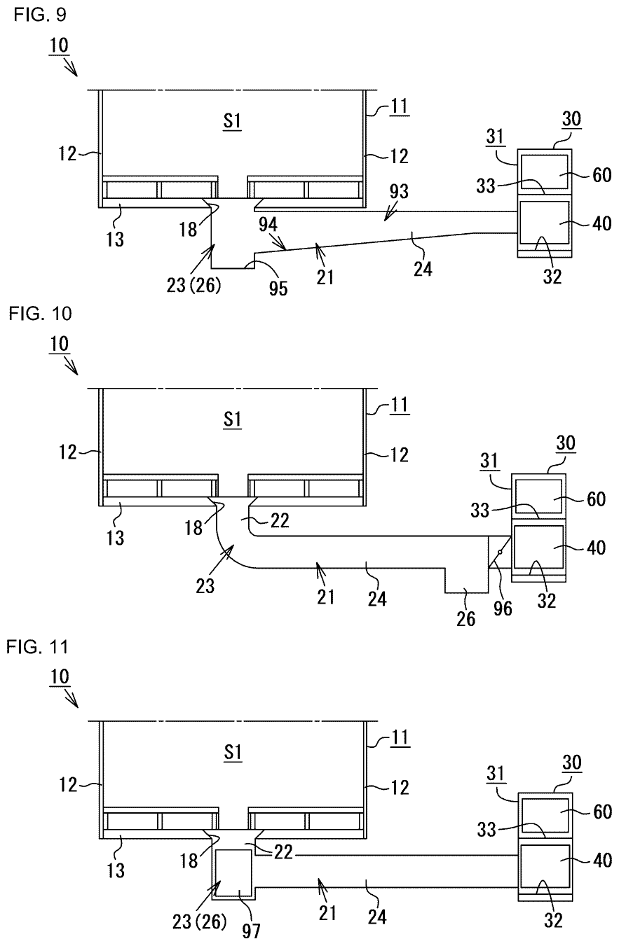

As shown in FIG. 9, a rectifying section 93 having a bottom surface 94 with a downward slope that gradually becomes lower toward the direction-changing section 23 may be formed in the transverse duct 24 of the air transfer passage 21. In this case, when the transverse duct 24 becomes contaminated, if cleaning (for example, jet cleaning) is performed by introducing a cleaning liquid into the inside of the transverse duct 24 from the side of the paint mist removal device 30, paint mist adhering to the bottom surface 94 of the transverse duct 24 flows into the direction-changing section 23 together with the cleaning liquid. Accordingly, cleaning inside the air transfer passage 21 is facilitated. Furthermore, a sedimentation sump 95 may be provided at the lower portion of the dust collection section 26 (direction-changing section 23). In this manner, since paint mist accumulated in the dust collection section 26 can be collected in the sedimentation sump 95, cleaning inside the air transfer passage 21 can be further facilitated.

In the above embodiment, the dust collection section 26 is provided in the direction-changing section 23; however, the dust collection section 26 may be provided at another location. For example, as shown in FIG. 10, the dust collection section 26 may be provided at the terminal end portion of the transverse duct 24 of the air transfer passage 21. In this case, it is preferable to provide, between the dust collection section 26 and the paint mist removal device 30, a blocking member 96 which may be composed of a door, shutter, or damper that blocks communication between the two. In this way, intrusion of paint mist accumulated in the dust collection section 26 into the paint mist removal device 30 can be prevented.

As shown in FIG. 11, a prefilter 97 for removing paint mist contained in the booth air A2 may be accommodated within the dust collection section 26 of the air transfer passage 21. The prefilter 97 is, for example, a corrugated cardboard filter having a rectangular box-like shape. The prefilter 97 includes an inlet for introducing the booth air A2 discharged from the booth space S1, a straightening plate for changing the flow direction of the booth air A2 from downward to lateral (rightward in FIG. 11), and an outlet for discharging the booth air A2 into the transverse duct 24.

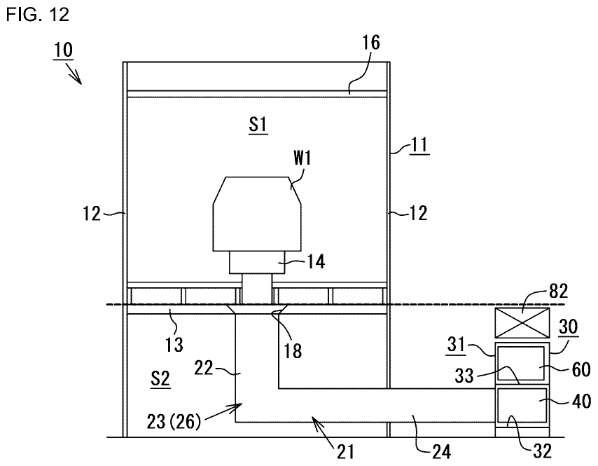

In the above embodiment, the exhaust duct 82 was installed at a position offset in the width direction of the coating line 14 so as to avoid the booth underfloor space S2, and was disposed above the floor portion 13 of the coating booth 11. However, as shown in FIG. 12, the exhaust duct 82 may alternatively be disposed below the floor portion 13.

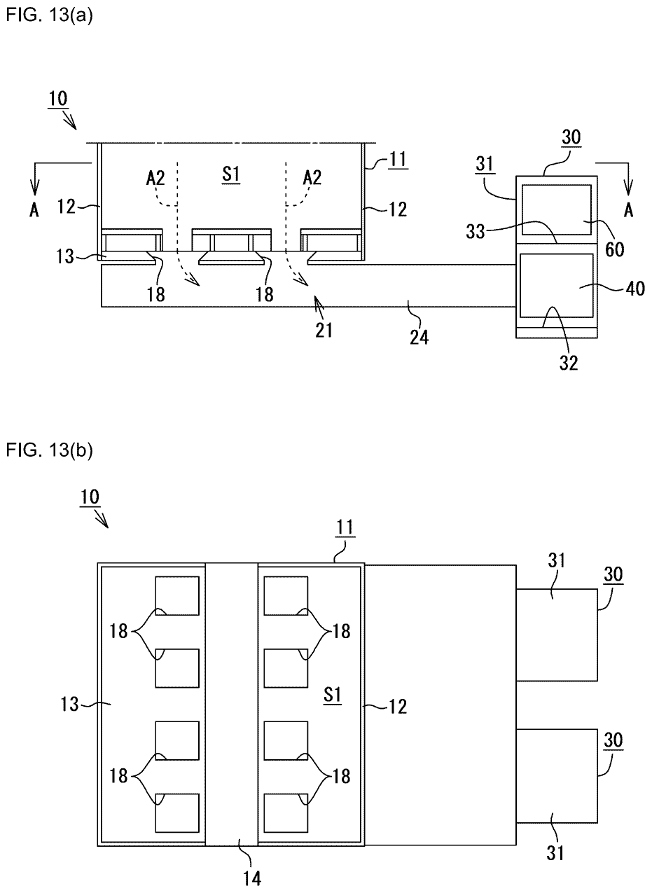

In the above embodiment, the exhaust port 18 through which the booth air A2 passes was disposed only at the center of the floor portion 13. However, the exhaust ports 18 may be disposed at a plurality of locations on the floor portion 13. For example, as shown in FIG. 13(a), the exhaust ports 18 may be disposed at two locations on the floor portion 13. Furthermore, as shown in FIG. 13(b), the exhaust ports 18 may be disposed at a plurality of locations along the longitudinal direction of the coating line 14 (the conveyance direction of the workpieces W1). Alternatively, instead of providing the exhaust ports 18, the floor portion 13 may have a grating structure such that the booth air A2 passes through the entire floor portion 13.

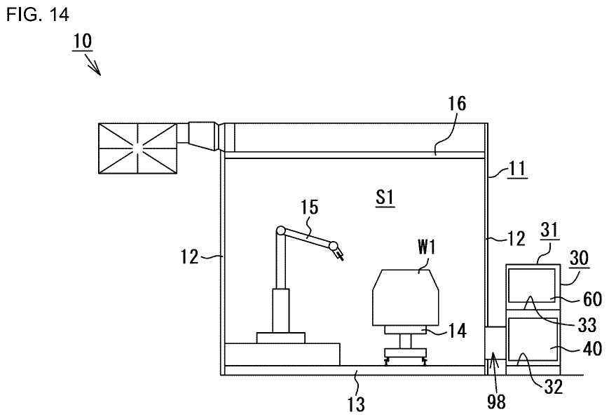

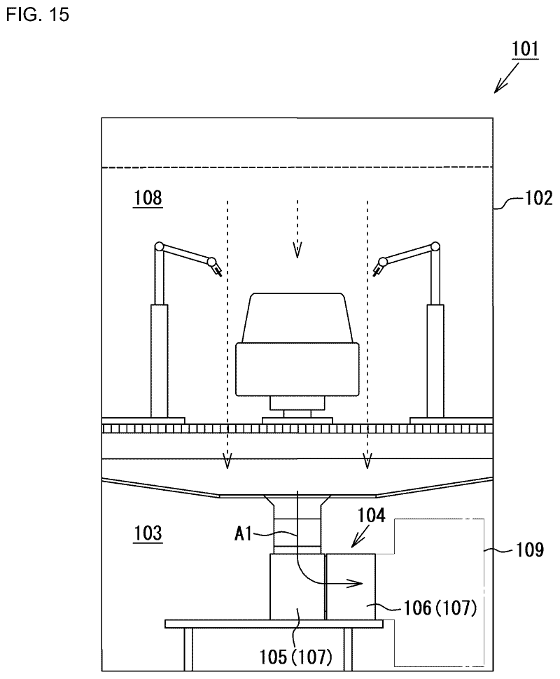

In the above embodiment, the air transfer passage 21 was formed in the booth underfloor space S2. However, as shown in FIG. 14, an air transfer passage 98 may be disposed at a position offset in the width direction of the coating line 14 so as to avoid the booth space S1, specifically on the side of the side wall 12 of the coating booth 11 (right side in FIG. 14). In this case, the paint mist removal device 30 is disposed at a position offset in the width direction of the coating line 14 so as to avoid the booth space S1, at the same height as the floor portion 13. In this manner, the overall height of the coating booth 11 can be further reduced.

In the above embodiment, a plurality of paint mist removal devices 30 may be disposed along the longitudinal direction of the coating line 14 (the conveyance direction of the workpieces W1) (see FIG. 13(b)). In this manner, a large amount of booth air A2 can be treated efficiently.

In the paint mist removal device 30 of the above embodiment, the filter housing 31 was configured to accommodate the corrugated cardboard filter 40 (primary filter) and the secondary filters 60. However, the filter housing 31 may further be configured to accommodate tertiary or higher-stage filters.

In the above embodiment, each of the descending duct 22, the transverse duct 24, the connection duct 25, and the ascending duct 81 was formed with a rectangular cross section. However, they may be formed with other cross-sectional shapes, such as circular, elliptical, or triangular cross section.

In the above embodiment, an automobile body was exemplified as the workpiece W1 to be coated in the coating booth 11; however, the present invention is not limited thereto. For example, the workpiece W1 may be an automotive interior component, such as an instrument panel, a console box, or an armrest, or an automotive exterior component, such as a bumper or an aerodynamic accessory (e.g., a spoiler). The workpiece W1 is not necessarily limited to automotive components.

In addition to the technical ideas set forth in the claims, further technical ideas that can be understood from the foregoing embodiments are listed below.
(1) The coating equipment according to claim 3, wherein the exhaust duct is disposed above the floor portion.
(2) The coating equipment according to any one of claims 1 to 9, wherein the height of the booth underfloor space is smaller than that of the filter housing.
(3) The coating equipment according to any one of claims 7 to 9, wherein a door for blocking communication between the inside and outside of the dust collection section is installed in the dust collection section.
(4) The coating equipment according to claim 7 or 8, wherein a prefilter configured to remove paint mist contained in the booth air is housed in the dust collection section.
(5) The coating equipment according to any one of claims 1 to 9, wherein a plurality of paint mist removal devices are installed along the longitudinal direction of the coating line.
(6) The coating equipment comprising:
   a coating booth having a pair of side walls and a floor portion, wherein a booth space is defined above the floor portion to accommodate a coating line, and the coating booth is configured to perform coating on a workpiece while conveying the workpiece along a longitudinal direction of the coating line; and
   a paint mist removal device having a filter housing configured to accommodate a primary filter and a secondary filter,
wherein booth air discharged from the booth space is caused to flow through the primary filter and the secondary filter accommodated in the filter housing to remove paint mist contained in the booth air,
the paint mist removal device being installed at a position offset in the width direction of the coating line so as to avoid the booth space, at the same height as the floor portion, and an air transfer passage connecting the booth space and the paint mist removal device being formed at a position offset in the width direction of the coating line.

### DESCRIPTION OF REFERENCE NUMERALS

10 ... Coating equipment
11 ... Coating booth
12 . . . Side wall
13 . . . Floor portion
14 . . . Coating line
21 . . . Air transfer passage
22 . . . Descending duct
23 . . . Direction-changing section
24 . . . Transverse duct
26 . . . Dust collection section
30 . . . Paint mist removal device
31 . . . Filter housing
32 . . . Lower housing portion
33 . . . Upper housing portion
35 . . . Inlet
36 . . . Outlet
40 . . . Corrugated cardboard filter (primary filter)
60 . . . Secondary filter
82 . . . Exhaust duct
93 . . . Rectifying section
94 . . . Downwardly inclined bottom surface
95 . . . Sedimentation sump
A2 . . . Booth air
S1 . . . Booth space
S2 . . . Booth underfloor space
W1 . . . Workpiece

1. A coating equipment comprising:
a coating booth having a pair of side walls and a floor portion,
wherein a booth space is defined above the floor portion so as to accommodate a coating line,
a booth underfloor space is defined below the floor portion, and
the coating booth is configured to perform coating on a workpiece while conveying the workpiece along a longitudinal direction of the coating line; and
a paint mist removal device having a filter housing configured to accommodate a primary filter and a secondary filter,
wherein booth air discharged from the booth space is caused to flow through the primary filter and the secondary filter accommodated in the filter housing to remove paint mist contained in the booth air,
wherein the paint mist removal device is installed at a position offset in a width direction of the coating line so as to avoid the booth underfloor space.

2. The coating equipment according to claim 1, wherein the paint mist removal device is installed at a position spaced apart from the side wall.

3. The coating equipment according to claim 2, wherein an exhaust duct is connected to an outlet of the filter housing, and the exhaust duct is installed at a position offset in a width direction of the coating line so as to avoid the booth underfloor space.

4. The coating equipment according to claim 1, wherein the primary filter and the secondary filter are arranged vertically adjacent to each other within the filter housing.

5. The coating equipment according to claim 4, wherein the filter housing has a lower housing portion and an upper housing portion, the primary filter is removably accommodated in the lower housing portion, and the secondary filter is removably accommodated in the upper housing portion.

6. The coating equipment according to claim 5, wherein the filter housing has an inlet for introducing booth air into the primary filter in the lower housing portion, and an outlet for discharging the booth air from the secondary filter in the upper housing portion.

7. The coating equipment according to claim 1, wherein an air transfer passage connecting the booth space and the paint mist removal device is formed in the booth underfloor space, and a dust collection section configured to remove paint mist contained in the booth air is provided at a position on the air transfer passage.

8. The coating equipment according to claim 7,
wherein the air transfer passage includes a descending duct extending downward from a central portion of the floor portion,
a direction-changing section connected to a terminal end of the descending duct and configured to change a traveling direction of the booth air, and
a lateral duct connected to the direction-changing section and extending laterally toward the paint mist removal device,
the direction-changing section being provided with the dust collection section, and the lateral duct being formed with a rectifying section having a downwardly inclined bottom surface that becomes lower toward the direction-changing section.

9. The coating equipment according to claim 8, wherein a sedimentation sump is provided at a lower portion of the dust collection section.
